(19) United States
(12) Patent Application Publication
(10) Pub. No.: US 2020/0302466 A1
(43) Pub. Date: Sep. 24, 2020

(54) USAGE-BASED ALLOCATION OF AN INCENTIVE POOL

(71) Applicant: Apple Inc., Cupertino, CA (US)

(72) Inventors: Alastair Moir Leishman MORSE, San Francisco, CA (US); Dana J. DUBOIS, San Francisco, CA (US); Alex R. ROFMAN, Palo Alto, CA (US); Jordano Bruno Eugene TONIAL, San Francisco, CA (US)

(21) Appl. No.: 16/826,026

(22) Filed: Mar. 20, 2020

Related U.S. Application Data
(60) Provisional application No. 62/822,706, filed on Mar. 22, 2019.

(51) Int. Cl. G06Q 30/02

(52) U.S. Cl. CPC G06Q 30/0219

(57) ABSTRACT

The subject technology receives information related to usage of a set of applications during a first period of time. The subject technology determines a first subset of the set of applications, where each application in the first subset is associated with at least one session having a duration greater than a first threshold amount of time. The subject technology determines a second subset of the set of applications, where each application in the second subset is associated with at least two sessions having an aggregate duration greater than a second threshold amount of time. The subject technology determines a set of values corresponding to respective allocation amounts for the first and second subsets of the set of applications. The subject technology allocates, to each respective developer of each respective application in the first and second subsets of the set of applications.

### CROSS REFERENCE TO RELATED APPLICATIONS

This application claims the benefit of priority to U.S. Provisional Patent Application No. 62/822,706, entitled “Usage-Based Allocation of an Incentive Pool,” and filed on Mar. 22, 2019, the disclosure of which is hereby incorporated herein in its entirety.

### TECHNICAL FIELD

The present description generally relates to providing incentives to developers to develop applications, including allocating incentives of an incentive pool to developers based on the usage of the applications they developed.

### BACKGROUND

Application developers create applications for users with different devices.

### BRIEF DESCRIPTION OF THE DRAWINGS

Certain features of the subject technology are set forth in the appended claims. However, for purpose of explanation, several embodiments of the subject technology are set forth in the following figures.

FIG. 1 illustrates an example network environment in accordance with one or more implementations.

FIG. 2 illustrates an example computing architecture for a system for providing a usage-based allocation of an incentive pool to an incentive pool developers in accordance with one or more implementations.

FIG. 3 illustrates an example table showing information for determining an allocation of incentives to a developer for usage of their application by a user in accordance with one or more implementations.

FIG. 4 illustrates an example table including information showing respective allocation amounts based on tallies for each application discussed in FIG. 3 in accordance with one or more implementations.

FIG. 5 illustrates example fields of data and corresponding data types in connection with determining allocations of incentives in accordance with one or more implementations.

FIG. 6 illustrates a flow diagram of an example process for determining respective allocation amounts to developers of respective applications using usage information in accordance with one or more implementations.

FIG. 7 illustrates an electronic system with which one or more implementations of the subject technology may be implemented.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a thorough understanding of the subject technology. However, the subject technology is not limited to the specific details set forth herein and can be practiced using one or more other implementations. In one or more implementations, structures and components are shown in block diagram form in order to avoid obscuring the concepts of the subject technology.

The subject technology provides implementations of a usage-based allocation of an incentive pool, such as to incentivize developers to develop applications that are regularly used by users. In an example, an allocation model as described further herein is designed to incentivize and reward behaviors that align developer's incentives with goals of the subject technology including: 1) meaningful engagement with an application (e.g., a game), 2) utilizing the application on multiple device families, and 3) healthy stickiness where non-addictive types of user behavior are encouraged.

An example goal of the subject technology is to provide an allocation to developers from a fixed incentive pool (e.g., a fixed amount of financial incentives or monetary value) on meaningful engagement with their applications over a period of time that is considered qualified usage activity where the entire incentive pool is allocated at the end of the period of time, such as the end of an hour, the end of a day, the end of a week, the end of a month, the end of a year, etc. In an implementation, the subject system divides a fixed incentive pool of a particular period of time (e.g., X) equally amongst a number of a second period of time (e.g., Y) where the second period of time corresponds to a smaller portion of the X period of time, which then yields a portion of the fixed incentive pool (e.g., X/Y) that is allocated to developers at the end of each Y period of time for qualified usage over that Y period of time.

The threshold for each qualified usage event over the Y period of time may be set by a server and provided to the user devices that use the applications developed by the developers. For example, a qualified usage event may be a certain amount of time of engagement with an application, such as one minute, 10 minutes, 30 minutes, one hour, or any amount of time. In one or more implementations, each developer may be limited to a fixed number of qualified usage events over the Y period of time for each unique user. For example, each developer may be limited to one qualified usage event per unique user over the Y period of time. In this manner, developers may receive allocations from the portion of the fixed incentive pool over the given Y period of time based on qualified usage with their application(s).

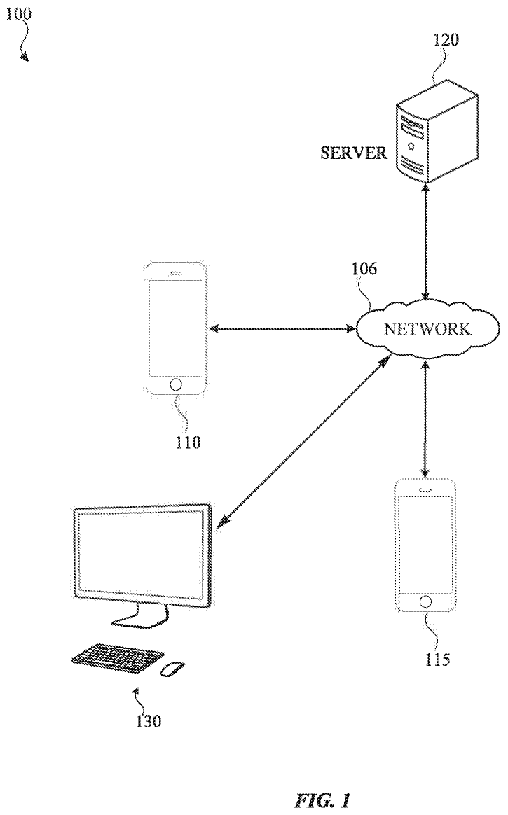

FIG. 1 illustrates an example network environment in accordance with one or more implementations. Not all of the depicted components may be used in all implementations, however, and one or more implementations may include additional or different components than those shown in the figure. Variations in the arrangement and type of the components may be made without departing from the spirit or scope of the claims as set forth herein. Additional components, different components, or fewer components may be provided.

The network environment 100 includes an electronic device 110, an electronic device 115, a server 120, and an electronic device 130. The network 106 may communicatively (directly or indirectly) couple the electronic device 110, the electronic device 115, the electronic device 130 and/or the server 120. In one or more implementations, the network 106 may be an interconnected network of devices that may include, or may be communicatively coupled to, the Internet. For explanatory purposes, the network environment 100 is illustrated in FIG. 1 as including the electronic device 110, the electronic device 115, the electronic device 130 and the server 120; however, the network environment 100 may include any number of electronic devices and any number of servers.

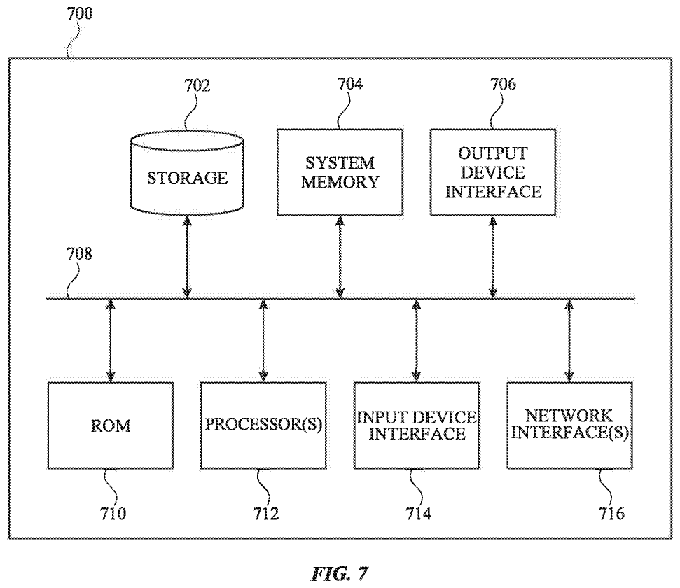

The electronic device 110 may be, for example, desktop computer, a portable computing device such as a laptop computer, a smartphone, a peripheral device (e.g., a digital camera, headphones), a tablet device, a wearable device such as a watch, a band, a smart speaker, a streaming device, and the like. In FIG. 1, by way of example, the electronic device 110 is depicted as a mobile electronic device (e.g., smartphone). The electronic device 110 may be, and/or may include all or part of, the electronic system discussed below with respect to FIG. 7.

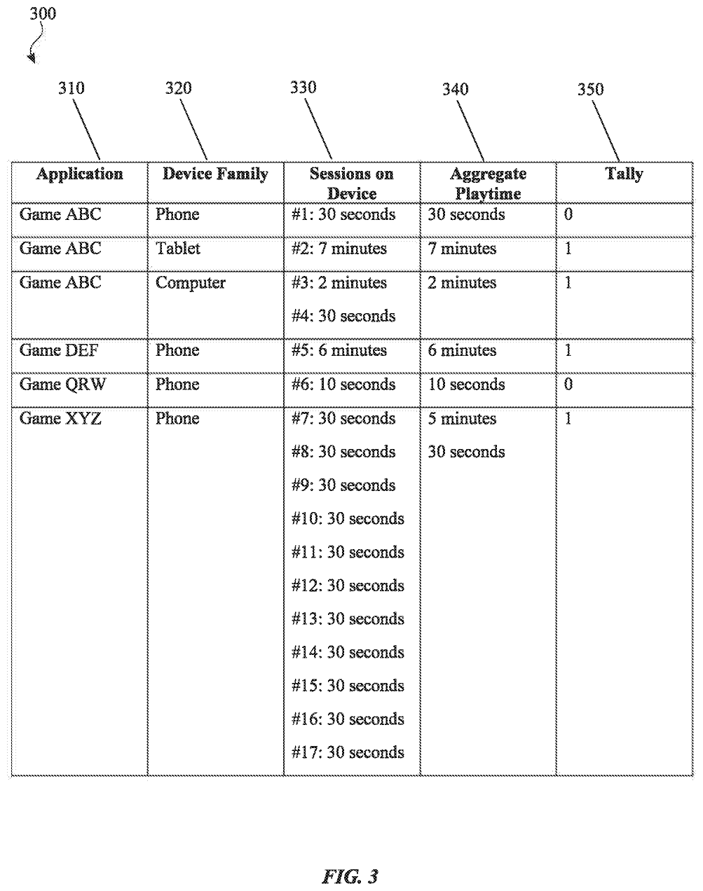

In one or more implementations, the electronic device 110 may provide a system for logging information related to usage activity from one or more applications on the electronic device 110. For example, a software component such as an application usage monitor (discussed further below) may be provided by the electronic device 110. The application usage monitor, which may be implemented as a background process or daemon (e.g., system process with special privileges), can track usage of applications executing on the electronic device 110 and store information related to the usage on the device. Such usage activity mentioned above and discussed further herein in FIGS. 3-5 can include information pertaining to which application (e.g., name) was used, a period of time (e.g., duration of time) during which the application was used, and/or when the application was used (e.g., date and time), etc.

As further shown, the electronic device 115 may provide a system for logging usage activity from one or more applications on the electronic device 115 using an application usage monitor in a similar manner as the electronic device 110.

As described further herein, users may subscribe to respective applications (e.g., via a given subscription model). In an example, a user may sign up for a subscription to a given application where the subscription includes a trial period (e.g., free during the trial where the user is not charged for using the application). Usage of the application (e.g., that occurs over a first threshold period of time for a single session, or aggregately occurs over a second threshold period of time for two or more sessions) counts toward determining an allocation of the fixed incentive pool during the trial period. If the user decides to remain on the subscription past the trial period, that user is considered a subscriber and usage of the application will also count toward determining an allocation of the fixed incentive pool. When the user cancels the subscription, the user is considered a churn user and activity after the cancellation does not count toward determining an allocation of the fixed incentive pool. The aforementioned allocations of the fixed incentive pool are then utilized as a basis to provide a financial incentive to the developer of the application.

The server 120 may provide a system for receiving the aforementioned usage information from one or more electronic devices, such as the electronic device 110 and the electronic device 115. The electronic device 110, for example, may communicate with the server 120 to provide such usage information for activity performed in one or more applications on the device. Similarly, the electronic device 115 can also communicate with the server 120 to provide such usage information logged by the application usage monitor on the device. As discussed further below, the server 120 can determine an allocation of an incentive pool (e.g., financial incentives) to the respective developer of each application. Information included in the usage data can be utilized to identify an application and/or the developer of an application. As discussed further herein, a set of criteria (e.g., one or more thresholds) is utilized for qualifying usage, based on a tallying scheme discussed further herein, of each application for an allocation. In one or more implementations, the server 120 may determine the criteria and/or thresholds and/or the server 120 may provide the criteria and/or thresholds to one or more of the electronic devices 110, 115.

The server 120, in an implementation, is configured to provide user privacy protection with respect to associating activity with users, including obfuscation of identifiers for users where a given identifier received by the server 120 is obfuscated against another identifier associated with stored information corresponding to the user. In an example, an account of a user is associated with an identifier “12456” but the server 120 may instead receive an identifier corresponding to “ABCDEF”. In an implementation, the server 120 is enabled to map the “ABCDEF” identifier to the identifier “12456”. This implementation further enables the user to invoke privacy rights where a link between the identifier “12456” and the identifier “ABCDEF” is severed thereby the information stored for identifier “12456” is disassociated to the identifier “ABCDEF” (e.g., preventing mapping).

As further shown, the electronic device 130 may correspond to a developer of an application that was indicated as being used on the electronic device 110 and/or the electronic device 115 was included in the usage information provided to the server 120. Although one electronic device is included in FIG. 1, it is understood that more than one electronic device may be included where each additional electronic device corresponds to a respective developer of a given application that may be used on the electronic device 110 and the electronic device 115.

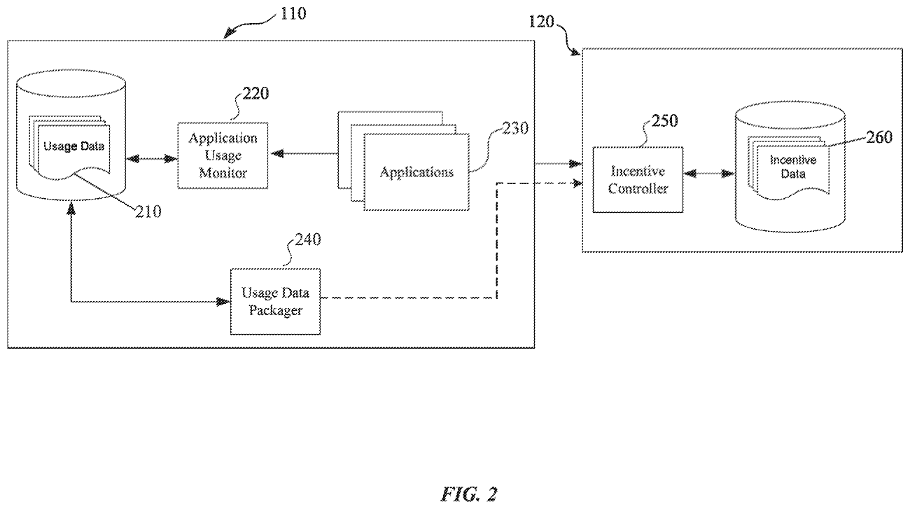

FIG. 2 illustrates an example computing architecture for a system for providing a usage-based allocation of an incentive pool to an incentive pool developers in accordance with one or more implementations. For explanatory purposes, the computing architecture is described as being provided by the electronic device 110, and the server 120 of FIG. 1, such as by a processor and/or memory of the electronic device 110 and/or the server 120; however, the computing architecture may be implemented by any other electronic devices. Not all of the depicted components may be used in all implementations, however, and one or more implementations may include additional or different components than those shown in the figure. Variations in the arrangement and type of the components may be made without departing from the spirit or scope of the claims as set forth herein. Additional components, different components, or fewer components may be provided.

As illustrated, the electronic device 110 includes an application usage monitor 220 that logs application usage data received from one or more applications 230. Information included in the application usage data can indicate a respective developer (e.g., company or entity) that created or is associated with each application from the applications 230. As further shown, the application usage monitor 220 can store the application usage data as usage data 210 in a database in memory or other storage device.

A usage data packager 240, as further shown in the electronic device 110, which may be implemented as a system process (e.g., daemon), packages the stored usage data 210 on an opportunistic and/or periodic basis (e.g., each minute, hour, day, etc.), and sends the usage data to the server 120 for further processing to determine allocations for developers. In an implementation, the usage data packager 240 corresponds to a process that wakes up once every period of time (e.g., twelve hours) and retrieves the usage data 210, serializes the retrieved usage data and sends the serialized usage data to the server 120.

As shown in the example of FIG. 2, the server 120 includes an incentive controller 250. The incentive controller 250 can receive usage data from the electronic device 110 (e.g., sent by the usage data packager 240) and store the usage data as part of incentive data 260. In an implementation, the incentive data 260 may include the received usage data and additional information as the incentive controller processes the usage data to determine payouts for developers (e.g., a developer corresponding to the electronic device 130), which is discussed in more detail in FIG. 3 below.

Further, although the electronic device 115 is not shown in FIG. 2., it is appreciated that the electronic device 115 may include similar components (e.g., application usage monitor, usage data packager, etc.) and interact with the server 120 in a similar way to provide usage activity of applications as discussed above in connection with the electronic device 110.

The following discussion describes various terms or phrases mentioned herein. As mentioned herein, a qualified session refers to a session (e.g., single app open, time spent using app. app close) that is longer than a threshold amount of time (e.g., 1 minute, 10 minutes, 30 minutes, an hour, etc.). In an implementation, a qualified session is associated with activity from a user in an eligible subscriber state or a user in an eligible account for activity, which is discussed further below. As mentioned herein, an aggregate qualified playtime refers to a sum of session times for an application in a given first period of time (e.g., a week) that exceeds a second period of time (e.g., 5 minutes). In an example, twenty sessions at thirty seconds long would result in ten minutes of playtime and, as a result, would qualify as a qualified session. As mentioned herein, an active qualified user refers to a user in the aforementioned first period of time with either 1) a qualified session for at least one application, or 2) an aggregate qualified playtime for at least one application. Further, the account must be in an eligible subscriber state or the account must be an eligible account for activity in order for the session or aggregate playtime to qualify. Additionally, as mentioned herein, a device family refers to a set of devices of a particular device type, such as a set of phones, a set of computers, a set of streaming devices, etc.

The following discussion describes eligible subscriber states and eligible accounts. In an implementation, usage activity within a period while deemed eligible is counted towards engagement (e.g. if a user cancels an account mid-week, the usage is still counted while the account was not cancelled). Users can be included in a trial period and/or be classified as a paid subscriber.

As described before, users may subscribe to respective applications (e.g., via a given subscription model). In an example, a user may sign up for a subscription to a given application where the subscription includes a trial period (e.g., free during the trial where the user is not charged for using the application). Usage of the application (e.g., that occurs over a first threshold period of time for a single session, or aggregately occurs over a second threshold period of time for two or more sessions) counts toward determining an allocation of the fixed incentive pool during the trial period. If the user decides to remain on the subscription past the trial period, that user is considered a subscriber and usage of the application will also count toward determining an allocation of the fixed incentive pool. When the user cancels the subscription, the user is considered a churn user and activity after the cancellation does not count toward determining an allocation of the fixed incentive pool. The aforementioned allocations of the fixed incentive pool are then utilized as a basis to provide a financial incentive to the developer of the application.

During a launch period, trial and paid subscribers can be eligible for qualified sessions to be used in the allocation of the incentive pool to developers. During a post-launch period, the system (e.g., the incentive controller 250) can make a decision to begin to exclude sessions/playtime of users who are in free trials. In an example where the subject system only considers users that are not in a free trial, the system can consider such users as paid subscribers if the users were in a paid state at the end of the period (e.g., fiscal week). Moreover, in an implementation, a launch period can be over a lengthy period of time (e.g., 3-6 months). Thus, the system enables an allocation pipeline that is flexible over such a lengthy period of time.

In an implementation, in order for a user's session/playtime to be used in the allocation of the incentive pool to developers, the user cannot be in a churned state. As mentioned herein, a churned state refers to when a user has canceled (e.g., closed or deactivated) an account. Usage activity before the user has canceled the account, however, may be considered as qualifying. In an example, a churn state can occur via a cancellation of a user's account. For example, a user signs up for a free trial, and the user performs a cancellation prior to a first billing cycle. In this example, the following describes which usage activity is considered qualified for consideration in the allocation of the incentive pool prior to the end of a first billing cycle:
Week 1: User signs up for a free trial: usage activity counts to the allocation of the incentive pool
Week 2: During the free trial: usage activity counts to the allocation of the incentive pool
Week 3: Cancellation of user account mid-week: usage activity counts towards the allocation of the incentive pool (albeit the user only had a few days to perform activity)

In an example, a chum state can occur prior to a second billing cycle. For example, a user can sign up for a free trial and performs usage activity over a first billing cycle, and, during a second billing, the user cancels the account prior to the end of the second billing cycle. In this example, the following describes which usage activity is considered qualified for consideration in the allocation of the incentive pool prior to the end of a second billing cycle:
Week 1: User signs up for a free trial: counts to allocation of incentive pool
Week 2: In free trial: counts to allocation of incentive pool
Week 3: Still in the free trial: counts to allocation of incentive pool
Week 4: Still in the free trial: counts to allocation of incentive pool
Week 5: User converts to a paid subscriber: counts to allocation of incentive pool
Week 6: User cancels account mid-week: counts towards allocation of incentive pool (albeit the user only had a few days to perform activity)

FIG. 3 illustrates an example table showing information for determining an allocation of incentives to a developer for usage of their application by a user in accordance with one or more implementations. FIG. 3 will be discussed by reference to FIG. 2, particularly with respect to respective components of the electronic device 110 and/or the server 120.

As mentioned previously, an example goal of the subject technology is to provide an allocation from a fixed incentive pool (e.g., a fixed amount of financial incentives or monetary value) on meaningful engagement over a period of time that is considered qualified usage activity where the entire incentive pool is allocated at the end of the period of time, such as the end of an hour, the end of a day, the end of a week, the end of a month, the end of a year, etc. In an implementation, the subject system (e.g., the incentive controller 250) divides an annual incentive pool (e.g., X) equally amongst 52 weeks, yielding a weekly fixed portion of the annual incentive pool (e.g., X/52) that is allocated to developers at the end of each week for qualified usage over that week.

For example, the subject system may allocate the weekly fixed portion of the incentive pool to developers based on the number of active qualified users for each of the developer's application(s) over the corresponding week. Thus, the weekly fixed portion of the incentive pool may be divided by the total number of active qualified users over the week to determine the allocation amount associated with each active qualified user of the developers' applications. In this example, an active qualified user of an application refers to a user with at least one qualified session or aggregate qualified playtime with the application over the corresponding week.

Each active qualified user's application usage over the period of time may be further segmented based on the number of different applications for which the user's activity would have qualified the user as an active qualified user on each device family, e.g., the number of different applications for which the user had a qualified session or aggregate qualified playtime on each device family over the period of time. Each different application on each device family for which a given user had a qualified session (or aggregated qualified playtime) may be allocated a tally for the given user. Thus, the subject system may then divide, for a given active qualified user, the allocation amount associated with each active qualified user for the time period by the total number of tallies for the given active qualified user to determine the amount allocated for each of the tallies of the given user for the time period. The subject system may then provide the amount allocated for each of the given user's tallies for the time period to the developers of each of the applications that received a tally for the user.

In FIG. 3, an example is disclosed of application usage of a particular user over a given week. FIG. 3 shows a table 300 with column 310 corresponding to an application name, column 320 corresponding to a device family, column 330 corresponding to sessions on a device, column 340 corresponding to an aggregate playtime, and column 350 corresponding to a tally. Below the aforementioned columns, information related to usage activity for a particular user “ABC123” in a week is included.

As shown in FIG. 3, usage of the particular user “ABC123” in the week includes 21 minutes and 10 seconds of aggregate playtime based on the sum of the values in the column 340. In this example, user ABC123 will be considered as an active qualified user for the allocation of the incentive pool since this user has used at least one application for over 1 minute during the time period. It is further noted that not all of the activity in FIG. 3 will get a tally for the user, e.g., Game QRW on the phone device family did not have a qualified session or aggregate qualified playtime in the week.

As further shown in FIG. 3, user ABC123's total number of tallies for the time period will be a tally of 4 (e.g., as shown in the column 350) based on the following: 1) Game ABC on the tablet device family receives a tally for the user as the user ABC123 had a session greater than 1 minute (e.g., a qualified session); 2) Game ABC also receives a tally for the user for the gaming on the computer device family as one of the two sessions qualified for a tally; 3) Game DEF also receives a tally for the user (as with the prior example); and 4) Game XYZ 2000 receives a tally for the user based on aggregate qualified playtime (e.g., more than 5 minutes of playtime in the week).

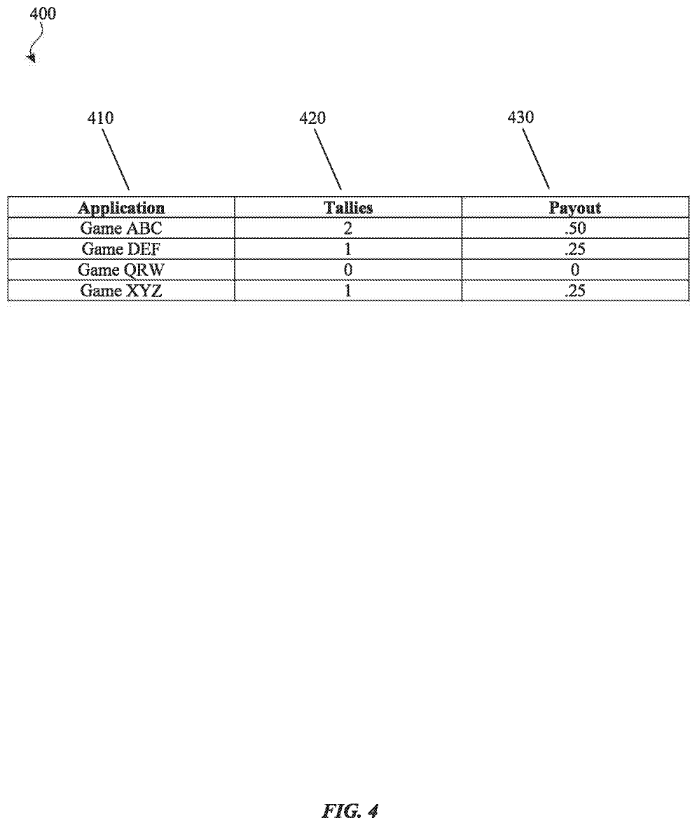

FIG. 4 illustrates an example table including information showing respective allocation amounts based on the user ABC 123's tallies for each application discussed in FIG. 3 in accordance with one or more implementations.

FIG. 4 shows a table 400 including a column 410 corresponding to an application name, a column 420 corresponding to a number of tallies, and a column 430 corresponding to a payout amount (e.g., an allocation amount). In the example of FIG. 4, user ABC123's has four tallies for the week, resulting in the value of each tally for the user ABC123 being one-fourth of the allocation amount associated with each active qualified user. Thus, if the allocation amount associated with each active qualified user was $1.00 for the time period, the value of each tally of the user ABC123 would be $0.25 (e.g., $1.00÷4).

The following discussion relates to a set of data representing usage data utilized by the subject system for calculating allocations from a fixed incentive pool, determining allocation analytics and modeling, and/or external reporting. Moreover, in an implementation, the set of data also includes information for installations, deletions, crashes and launch events of applications.

In an implementation, the set of data corresponds to the following groups of users and/or information. For example, the set of data may include data for all subscribers. Moreover, the set of data may include data for all ages (e.g., usage data does not exclude data for any age groups). The set of data may also include data related to content for the subject system. Further, the set of data may include data collected from different device families, platforms, and/or operating systems (e.g., phone, tablet, streaming device, computer, etc.).

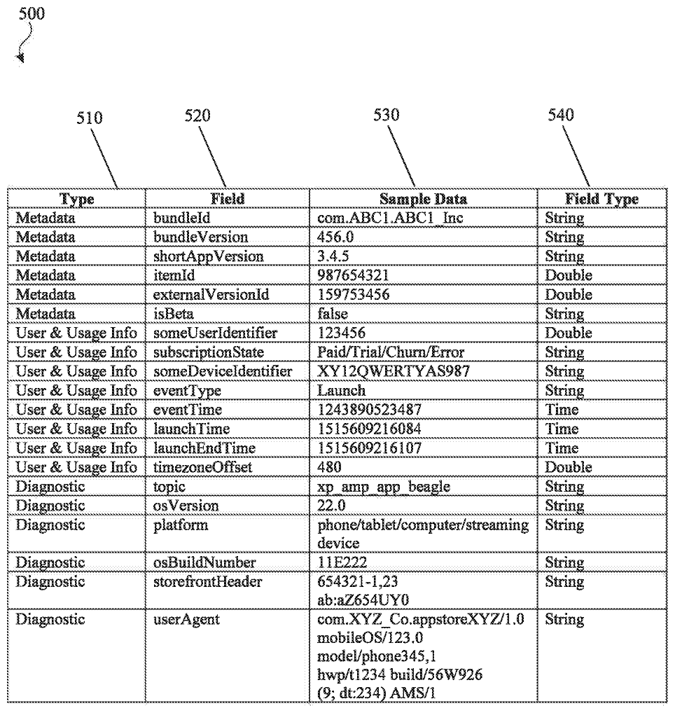

FIG. 5 illustrates example fields of data and corresponding data types in connection with determining allocations of incentives in accordance with one or more implementations.

FIG. 5 includes a table 500 with a column 510 corresponding to a type of data, a column 520 corresponding to a field, a column 530 corresponding to example data (e.g., “Sample data”), and a column 540 corresponding to a field type for each field included in the column 520. As shown in FIG. 5, different types included in the column 510 include metadata, user and usage information, and diagnostic. As further shown in FIG. 5, different types of field types include string, double, or time for values of corresponding fields.

The following discussion describes examples of different fields of metadata in the table 500. The “bundleId” field corresponds to a value of a bundle ID of an application. The “bundleVersion” field corresponds to a value of a bundle version from the information property list file (e.g., a structured text file that contains configuration information for a bundled executable). The “shortAppVersion” field corresponds to a value of an external version set by a developer, which may be visible to a user of the application. The “itemId” field corresponds to a value of a particular ID of an item. The “externalVersionId” field corresponds to a value of an external version of an application. The “isBeta” field corresponds to a value of a Boolean flag to indicate if an application is in beta or not.

The following discussion describes examples of different user and usage information in the table 500. The “someUserIdentifier” field corresponds to a value of a persistent user identifier. The “subscriptionState” field corresponds to a value of a string indicating a state of a user (e.g., paid, trial, churn, error). The “someDeviceIdentifier” field corresponds to a value of a persistent device identifier. The “eventType” field corresponds to a value of a type of event associated with an application (e.g., launch). The “eventTime” field corresponds to a value of a time when a first data source (e.g., an application) was queried for “launches” (e.g., when an application is executed) from a second data source storing information related to usage activity. The “launchTime” field corresponds to a value of a time when an application is executed. In an example, the value of the eventTime field will be later than the launchTime field and will be the same for all the events in a given request (e.g., post to store data). The “launchEndTime” field corresponds to a value of a time when an application has completed launching (e.g., application initialization has completed and is now included as an active process). The “timezoneOffset” field corresponds to a value of an offset for a time zone.

As further shown in the table 500, different diagnostic data may be included such as a “topic” field, “osVersion” field indicating a version of an operating system, “platform” field corresponding to a value of a device platform, “osBuildNumber” field corresponding to a value of a build number, “storefrontHeader” field, and a “userAgent” field corresponding to a type of user agent.

In implementation, the subject system (e.g., the incentive controller 250) can determine one or more metrics for reporting including an amount that a particular application receives in dollars in an allocation. Further, such a report can also include the math that explains the allocation such as the number of players that contributed, and number of players that did not qualify.

In an implementation, the subject system (e.g., the incentive controller 250) can provide external reports to developers. For example, the subject system can generate and distribute a weekly report to developers to let the developers know how well the developers performed in the shared incentive pool for a particular time period (e.g., week). Developers may receive performance for their applications only and not for the overall service including all applications for all developers. Examples of information utilized in generating external reports may include one or more of the following:
Week Start and End Date
Bonus Proceeds
Active Qualifying Players (per device family)
Since an application's bonus payment is dependent on how well it performs relative to other applications on the service, the Active Qualifying Players field will let developers know whether they are increasing their capacity to get paid, irrespective of the other applications on the service.
Active Non-Qualifying Players (per device family)
To help developers determine their missed opportunity that week.
ID Application Name Storefront

In an implementation, the external reports may be downloaded via an API, or viewed within a UI.

In an implementation, the subject system (e.g., the incentive controller 250) can generate a report for payout information, such as when allocations are in the form of payouts. In an example, this report may be aligned with a given fiscal calendar and is where developers go to understand the final payment, after taxes and adjustments, that developers will receive in their bank account that month. Examples of information utilized in generating reports for payout information include at least the following:
Developer Name
Fiscal Period
Bonus Week (Start and End date)
Application ID
App Name
Qualified Plays
Proceeds (USD)

In an implementation, the payout information reports may be downloaded via an API, or viewed within a UI. In an example, monthly financial reports contain the data from the last week of the previous fiscal month and all but the last week of the actual fiscal month being reported on (e.g., the January 2019 report would cover Dec. 23, 2018-Jan. 26, 2019). This is to ensure that developers are paid and reported the next month following earnings and not two months later. Further, a single payment will be provided for proceeds in the monthly financial report, and there may not be weekly payments in an implementation.

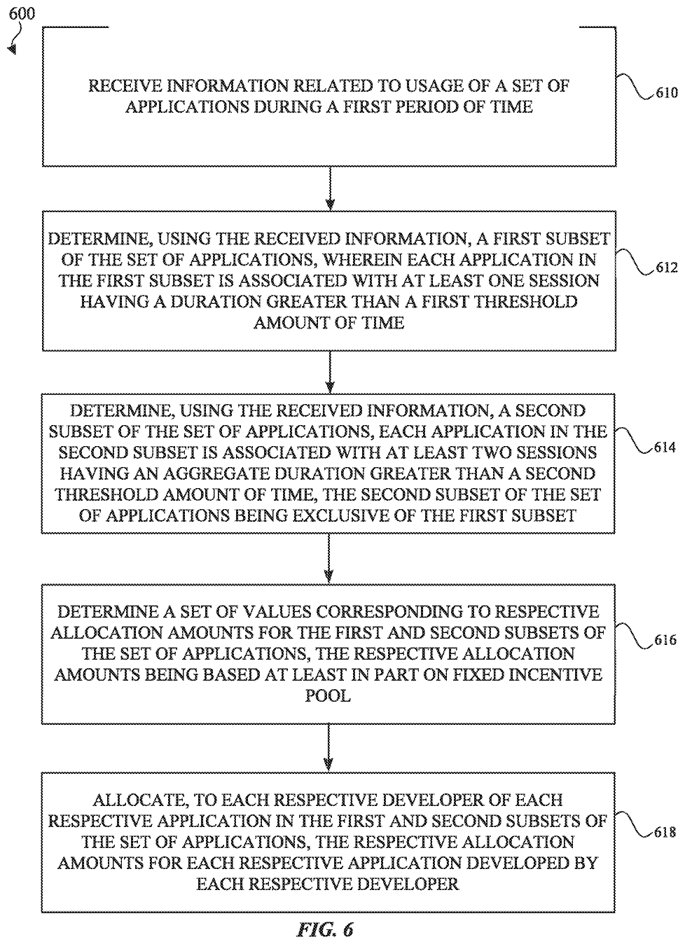

FIG. 6 illustrates a flow diagram of an example process for determining respective allocation amounts to developers of respective applications using usage information in accordance with one or more implementations. For explanatory purposes, the process 600 is primarily described herein with reference to components of the computing architecture of FIG. 2, which may be executed by one or more processors of the server 120 of FIG. 1. However, the process 600 is not limited to the server 120, and one or more blocks (or operations) of the process 600 may be performed by one or more other components of other suitable devices, such as by the electronic device 110, the electronic device 115, or another server. Further for explanatory purposes, the blocks of the process 600 are described herein as occurring in serial, or linearly. However, multiple blocks of the process 600 may occur in parallel. In addition, the blocks of the process 600 need not be performed in the order shown and/or one or more blocks of the process 600 need not be performed and/or can be replaced by other operations.

The server 120 receives information related to usage of a set of applications during a first period of time (610). The server 120 determines, using the received information, a first subset of the set of applications, wherein each application in the first subset is associated with at least one session having a duration greater than a first threshold amount of time (612).

The server 120 determines, using the received information, a second subset of the set of applications, wherein each application in the second subset is associated with at least two sessions having an aggregate duration greater than a second threshold amount of time, the second subset of the set of applications being exclusive of the first subset of the set of applications (614). The server 120 determines a set of values corresponding to respective allocation amounts for the first and second subsets of the set of applications, the respective allocation amounts being based at least in part on fixed incentive pool (616). The server 120 allocates, to each respective developer of each respective application in the first and second subsets of the set of applications, the respective allocation amounts for each respective application developed by each respective developer (618).

FIG. 7 illustrates an electronic system 700 with which one or more implementations of the subject technology may be implemented. The electronic system 700 can be, and/or can be a part of, the electronic device 110, the server 120, the electronic device 130, and/or the server 120 shown in FIG. 1. The electronic system 700 may include various types of computer readable media and interfaces for various other types of computer readable media. The electronic system 700 includes a bus 708, one or more processing unit(s) 712, a system memory 704 (and/or buffer), a ROM 710, a permanent storage device 702, an input device interface 714, an output device interface 706, and one or more network interfaces 716, or subsets and variations thereof.

The bus 708 collectively represents all system, peripheral, and chipset buses that communicatively connect the numerous internal devices of the electronic system 700. In one or more implementations, the bus 708 communicatively connects the one or more processing unit(s) 712 with the ROM 710, the system memory 704, and the permanent storage device 702. From these various memory units, the one or more processing unit(s) 712 retrieves instructions to execute and data to process in order to execute the processes of the subject disclosure. The one or more processing unit(s) 712 can be a single processor or a multi-core processor in different implementations.

The ROM 710 stores static data and instructions that are needed by the one or more processing unit(s) 712 and other modules of the electronic system 700. The permanent storage device 702, on the other hand, may be a read-and-write memory device. The permanent storage device 702 may be a non-volatile memory unit that stores instructions and data even when the electronic system 700 is off. In one or more implementations, a mass-storage device (such as a magnetic or optical disk and its corresponding disk drive) may be used as the permanent storage device 702.

In one or more implementations, a removable storage device (such as a floppy disk, flash drive, and its corresponding disk drive) may be used as the permanent storage device 702. Like the permanent storage device 702, the system memory 704 may be a read-and-write memory device. However, unlike the permanent storage device 702, the system memory 704 may be a volatile read-and-write memory, such as random access memory. The system memory 704 may store any of the instructions and data that one or more processing unit(s) 712 may need at runtime. In one or more implementations, the processes of the subject disclosure are stored in the system memory 704, the permanent storage device 702, and/or the ROM 710. From these various memory units, the one or more processing unit(s) 712 retrieves instructions to execute and data to process in order to execute the processes of one or more implementations.

The bus 708 also connects to the input and output device interfaces 714 and 706. The input device interface 714 enables a user to communicate information and select commands to the electronic system 700. Input devices that may be used with the input device interface 714 may include, for example, alphanumeric keyboards and pointing devices (also called “cursor control devices”). The output device interface 706 may enable, for example, the display of images generated by electronic system 700. Output devices that may be used with the output device interface 706 may include, for example, printers and display devices, such as a liquid crystal display (LCD), a light emitting diode (LED) display, an organic light emitting diode (OLED) display, a flexible display, a flat panel display, a solid state display, a projector, or any other device for outputting information. One or more implementations may include devices that function as both input and output devices, such as a touchscreen. In these implementations, feedback provided to the user can be any form of sensory feedback, such as visual feedback, auditory feedback, or tactile feedback; and input from the user can be received in any form, including acoustic, speech, or tactile input.

Finally, as shown in FIG. 7, the bus 708 also couples the electronic system 700 to one or more networks and/or to one or more network nodes, such as the electronic device 110 shown in FIG. 1, through the one or more network interface(s) 716. In this manner, the electronic system 700 can be a part of a network of computers (such as a LAN, a wide area network (“WAN”), or an Intranet, or a network of networks, such as the Internet. Any or all components of the electronic system 700 can be used in conjunction with the subject disclosure.

Implementations within the scope of the present disclosure can be partially or entirely realized using a tangible computer-readable storage medium (or multiple tangible computer-readable storage media of one or more types) encoding one or more instructions. The tangible computer-readable storage medium also can be non-transitory in nature.

The computer-readable storage medium can be any storage medium that can be read, written, or otherwise accessed by a general purpose or special purpose computing device, including any processing electronics and/or processing circuitry capable of executing instructions. For example, without limitation, the computer-readable medium can include any volatile semiconductor memory, such as RAM, DRAM, SRAM, T-RAM, Z-RAM, and TTRAM. The computer-readable medium also can include any non-volatile semiconductor memory, such as ROM, PROM, EPROM, EEPROM, NVRAM, flash, nvSRAM, FeRAM, FeTRAM, MRAM, PRAM, CBRAM, SONOS, RRAM, NRAM, racetrack memory, FJG, and Millipede memory.

Further, the computer-readable storage medium can include any non-semiconductor memory, such as optical disk storage, magnetic disk storage, magnetic tape, other magnetic storage devices, or any other medium capable of storing one or more instructions. In one or more implementations, the tangible computer-readable storage medium can be directly coupled to a computing device, while in other implementations, the tangible computer-readable storage medium can be indirectly coupled to a computing device, e.g., via one or more wired connections, one or more wireless connections, or any combination thereof.

Instructions can be directly executable or can be used to develop executable instructions. For example, instructions can be realized as executable or non-executable machine code or as instructions in a high-level language that can be compiled to produce executable or non-executable machine code. Further, instructions also can be realized as or can include data. Computer-executable instructions also can be organized in any format, including routines, subroutines, programs, data structures, objects, modules, applications, applets, functions, etc. As recognized by those of skill in the art, details including, but not limited to, the number, structure, sequence, and organization of instructions can vary significantly without varying the underlying logic, function, processing, and output.

While the above discussion primarily refers to microprocessor or multi-core processors that execute software, one or more implementations are performed by one or more integrated circuits, such as ASICs or FPGAs. In one or more implementations, such integrated circuits execute instructions that are stored on the circuit itself.

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or partitioned in a different way) all without departing from the scope of the subject technology.

It is understood that any specific order or hierarchy of blocks in the processes disclosed is an illustration of example approaches. Based upon design preferences, it is understood that the specific order or hierarchy of blocks in the processes may be rearranged, or that all illustrated blocks be performed. Any of the blocks may be performed simultaneously. In one or more implementations, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

As used in this specification and any claims of this application, the terms “base station”, “receiver”, “computer”., “server”, “processor”, and “memory” all refer to electronic or other technological devices. These terms exclude people or groups of people. For the purposes of the specification, the terms “display” or “displaying” means displaying on an electronic device.

As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B. or only C; any combination of A, B, and C; and/or at least one of each of A, B, and C.

The predicate words “configured to”, “operable to”, and “programmed to” do not imply any particular tangible or intangible modification of a subject, but, rather, are intended to be used interchangeably. In one or more implementations, a processor configured to monitor and control an operation or a component may also mean the processor being programmed to monitor and control the operation or the processor being operable to monitor and control the operation. Likewise, a processor configured to execute code can be construed as a processor programmed to execute code or operable to execute code.

Phrases such as an aspect, the aspect, another aspect, some aspects, one or more aspects, an implementation, the implementation, another implementation, some implementations, one or more implementations, an embodiment, the embodiment, another embodiment, some implementations, one or more implementations, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

The word “exemplary” is used herein to mean “serving as an example, instance, or illustration”. Any embodiment described herein as “exemplary” or as an “example” is not necessarily to be construed as preferred or advantageous over other implementations. Furthermore, to the extent that the term “include”, “have”, or the like is used in the description or the claims, such term is intended to be inclusive in a manner similar to the term “comprise” as “comprise” is interpreted when employed as a transitional word in a claim.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for”.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more”. Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

What is claimed is:

1. A method comprising:
receiving information related to usage of a set of applications during a first period of time;
determining, using the received information, a first subset of the set of applications, wherein each application in the first subset is associated with at least one session having a duration greater than a first threshold amount of time;
determining, using the received information, a second subset of the set of applications, wherein each application in the second subset is associated with at least two sessions having an aggregate duration greater than a second threshold amount of time, the second subset of the set of applications being exclusive of the first subset of the set of applications;
determining a set of values corresponding to respective allocation amounts for the first and second subsets of the set of applications, the respective allocation amounts being based at least in part on fixed incentive pool; and
allocating, to each respective developer of each respective application in the first and second subsets of the set of applications, the respective allocation amounts for each respective application developed by each respective developer.

2. The method of claim 1, wherein the first threshold amount of time and the second threshold amount of time are different periods of time.

3. The method of claim 1, wherein the first subset of the set of applications includes a first application on a first type of device, a second application on a second type of device that differs from the first type of device, and the first application and second application corresponding to a same application of a particular developer.

4. The method of claim 1, wherein the first period of time comprises one week.

5. The method of claim 1, wherein the fixed incentive pool corresponds to a period of time of a year, and determining the set of values corresponding to respective allocation amounts for the first and second subsets of the set of applications further comprises:
determining a portion of the fixed incentive pool based on a number of weeks over the year;
determining a number of unique users corresponding to the first subset of the set of applications and the second subset of the set of applications; and
determining a value of each unique user based on the portion of the fixed incentive pool divided by the number of unique users.

6. The method of claim 1, further comprising:
generating a report based on the respective allocation amounts for the first subset of the set of applications and the second subset of the set of applications.

7. The method of claim 1, wherein information related to usage of the set of applications during the first period of time corresponds to respective users.

8. The method of claim 7, further comprising:
determining a state of each of the respective users, the state indicating that each of the respective users is a subscriber, a trial user, or a churn user.

9. The method of claim 8, wherein when the state indicates that a particular user is a churn user, usage of a particular application is disqualified for an allocation amount.

10. A system comprising:
a processor;
a memory device containing instructions, which when executed by the processor cause the processor to:
receive information related to usage of a set of applications during a first period of time;
determine, using the received information, a first subset of the set of applications, wherein each application in the first subset is associated with at least one session having a duration greater than a first threshold amount of time;
determine, using the received information, a second subset of the set of applications, wherein each application in the second subset is associated with at least two sessions having an aggregate duration greater than a second threshold amount of time, the second subset of the set of applications being exclusive of the first subset of the set of applications;
determine a set of values corresponding to respective allocation amounts for the first and second subsets of the set of applications, the respective allocation amounts being based at least in part on fixed incentive pool; and
allocate, to each respective developer of each respective application in the first and second subsets of the set of applications, the respective allocation amounts for each respective application developed by each respective developer.

11. The system of claim 10, wherein the first threshold amount of time and the second threshold amount of time are different periods of time.

12. The system of claim 10, wherein the first subset of the set of applications includes a first application on a first type of device, a second application on a second type of device that differs from the first type of device, and the first application and second application corresponding to a same application of a particular developer.

13. The system of claim 10, wherein the first period of time comprises one week.

14. The system of claim 10, wherein the fixed incentive pool corresponds to a period of time of a year, and determining the set of values corresponding to respective allocation amounts for the first and second subsets of the set of applications further comprises:
determining a portion of the fixed incentive pool based on a number of weeks over the year;
determining a number of unique users corresponding to the first subset of the set of applications and the second subset of the set of applications; and
determining a value of each unique user based on the portion of the fixed incentive pool divided by the number of unique users.

15. The system of claim 10, wherein the memory device contains further instructions, which when executed by the processor cause the processor to further:
generate a report based on the respective allocation amounts for the first subset of the set of applications and the second subset of the set of applications.

16. The system of claim 10, wherein information related to usage of the set of applications during the first period of time corresponds to respective users.

17. The system of claim 16, wherein the memory device contains further instructions, which when executed by the processor cause the processor to further:
determine a state of each of the respective users, the state indicating that each of the respective users is a subscriber, a trial user, or a churn user.

18. The system of claim 17, wherein when the state indicates that a particular user is a churn user, usage of a particular application is disqualified for an allocation amount.

19. A non-transitory computer-readable medium comprising instructions, which when executed by a computing device, cause the computing device to perform operations comprising:
determining a portion of a fixed incentive pool based on a number of weeks over a year;
determining a number of unique users corresponding to a first subset of a set of applications and a second subset of the set of applications; and
determining a value of each unique user based on the portion of the fixed incentive pool divided by the number of unique users.

20. The non-transitory computer-readable medium of claim 19, wherein the number of unique users correspond to users that are subscribers or users in a trial period that at least include usage activity of a particular application over at least a first period of time.
